(19) United States
(12) Patent Application Publication
(10) Pub. No.: US 2006/0004172 A1
(43) Pub. Date: Jan. 5, 2006

(54) Preparation of clear isocyanate prepolymers based on hexanediolether carbonate

(75) Inventors: Hartmut Nefzger, Pulheim (DE); Manfred Schmidt, Dormagen (DE); James-Michael Barnes, Breitscheid (DE); Ernst Felske, Neuss (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/170,615

(22) Filed: Jun. 29, 2005

(30) Foreign Application Priority Data
Jul. 5, 2004 (DE) 102004032419.0

(51) Int. Cl. C08G 18/00

(52) U.S. Cl. 528/44

(57) ABSTRACT

The present invention relates to a process for the preparation of clear, storage-stable isocyanate-terminated prepolymers. These isocyanate-terminated prepolymers are based on hexanediolether carbonate. This invention also relates to the preparation of polyurethanes from these isocyanate-terminated prepolymers.

### BACKGROUND OF THE INVENTION

The present invention relates to an improved process for the preparation of isocyanate prepolymers based on polycarbonate polyols wherein the prepolymers are not cloudy.

In accordance with the prior art, polycarbonate polyols based on hexanediolether are reacted with a molar excess of polyisocyanate, generally 4,4′-diphenylmethane diisocyanate, to yield isocyanate prepolymers which have terminal NCO groups (“NCO prepolymers”). These isocyanate prepolymers are important raw materials for the preparation of polyurethane pourable elastomers.

A disadvantage of these NCO prepolymers, particularly those based on 4,4′-diphenylmethanediisocyanate and hexanediolether carbonate polyols, is that, in general, they rapidly turn cloudy during storage at room temperature, and may even form a semi-crystalline sediment. Increasing the storage temperature at which the NCO prepolymers are stored results in a marked rise in viscosity in the NCO prepolymers, and ultimately results in the prepolymers becoming unusable. The same is also the case, if NCO prepolymers which have once been cooled, and consequently show cloudiness or a sediment, are re-heated. During further reaction, the deposit results in inhomogeneities in the finished poured elastomer. These inhomogeneities can, in turn, give rise to material failure of the elastomer.

### SUMMARY OF THE INVENTION

The object was to provide a process for the preparation of these NCO prepolymers such that, as a result of technical improvements, the prepolymers will no longer become cloudy. It has now been found that NCO prepolymers can be prepared which are clear and exhibit no clouding even after prolonged storage at room temperature. This process requires the polycarbonate polyol, before being reacted with a polyisocyanate, to undergo a short-path or thin-film distillation in which readily volatile constituents having boiling points of below 200° C. at a pressure of 0.1 mbar are removed.

The present invention provides a process for the preparation of NCO-terminated prepolymers which are clear and are stable in storage at room temperature. This process comprises reacting polycarbonate polyols with a stoichiometric excess of 4,4′-diphenylmethane diisocyanate, wherein before the reaction the polycarbonate polyols undergo a short-path or thin-film distillation. This short-path or thin-film distillation results in the hydroxyl value of the polycarbonate polyol being reduced by at least 1.5 hydroxyl value units, and preferably at least 3 hydroxyl value units.

As used herein, the phrase “clear and stable in storage” means that the prepolymers show no cloudiness and the NCO group content of the prepolymers did not change significantly, even after three weeks' storage at 23° C.

The reduction of the hydroxyl value of the polycarbonate polyols by distillation is carried out in apparatus which are known to those skilled in the art. Suitable apparatus include, for example, falling-film evaporators, thin-film evaporators and molecular evaporators. It is preferred that the distillation takes place in continuous manner. The distillation is preferably carried out at temperatures of from 160 to 250° C., preferably 180 to 210° C., and at pressures of from 0.05 to 10 mbar, preferably 0.1 to 3 mbar. The distillate is separated in liquid form in a cold finger condenser where the temperature is selected within the range 40 to 100° C. The separated distillate can be utilised again for the preparation of polycarbonate polyols. The average residence time of the polycarbonate polyol in the distillation apparatus is preferably from 2 to 600 s.

The polycarbonate polyol is expediently heated, for example, with the aid of heat exchangers, before being continuously charged into the evaporating unit. In a preferred embodiment, the treatment of the polycarbonate polyol by distillation is immediately downstream of the preparation process for the polycarbonate polyol because in the final stage of production, the polycarbonate polyol is normally at a temperature of approx. 200° C. Consequently, there is no further energy expenditure. Immediately after leaving the distillation apparatus, the polycarbonate polyol is cooled to temperatures of below 120° C. The condenser for the distillate is generally heated to a temperature from 50 to 75° C., depending on the composition of the latter. In addition, the distillation apparatus is operated at reduced pressure in order to improve the effectiveness of the operation. Here, pressures of below 100 mbar, preferably below 20 mbar, are normal. The effectiveness may be further improved by adding a so-called entraining agent to the polycarbonate polyol. Suitable materials to be used as so-called entraining agents include a small quantity of an inert solvent which has a boiling point within the range 100 to 300°. Substances known to those skilled in the art, such as, for example, sulfolane, toluene or xylene, may be suitable for use as entraining agents.

Depending on its effectiveness, the distillation of the polycarbonate polyol reduces its hydroxyl value by about 1.5 to about 15 hydroxyl value units, and preferably about 3 to about 8 hydroxyl value units.

The polycarbonate polyol which has been pre-treated by distillation is then reacted, in the manner known to those skilled in the art, with a stoichiometric excess of 4,4′-diphenylmethane diisocyanate (which is commercially available from Bayer AG) at elevated temperature (generally within the range 50 to 100° C.), to yield a prepolymer having one or more terminal NCO groups. The polycarbonate polyols utilised in the process of the present invention typically have a hydroxyl value (i.e. an OH number) of from 27 to 113 mg KOH/g. The resultant prepolymers prepared in accordance with the present invention generally have a NCO group content of from 5 to 15 wt. % NCO.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Example 1

Preparation of a Polycarbonate Polyol:

9000 g of a commercially available polycarbonate polyol based on hexanediolether having a hydroxyl value of 53 mg KOH/g were mixed with 101 g 1,6-hexanediol, and annealed at 200° C. for 14 hours. The OH value of the resultant polycarbonate polyol was 63.7 mg KOH/g, and the viscosity of the resultant polycarbonate polyol was 840 mPas (75° C.).

### Example 2

Preparation of a Polycarbonate Polyol:

3900 g of a hexanediolether having a hydroxyl value of 535 mg KOH/g, 725 g of hexanediol and 4635 g of diphenyl carbonate were heated to 180° C. at standard pressure for 1 hour together with 150 mg of dibutyltin oxide. Cooling took place to 110° C., and the pressure was reduced to 15 mbar, with distillation of phenol commencing. The temperature was raised to 200° C. during the course of 10 hours. The pressure was reduced to 0.5 mbar for 1 hour in order to complete the reaction. The OH value of the resultant polycarbonate polyol was 62.5 mg KOH/g, and the viscosity of the resultant polycarbonate polyol was 910 mPas (75° C.).

### Example 3

Treatment of the Polycarbonate Polyol from Example 1 in Accordance with the Present Invention:

8900 g of the polycarbonate polyol produced in Example 1 was pre-heated to 160° C., and underwent a short-path evaporation at a pressure of <1 mbar over the course of 6 hours. The pre-evaporator was operated at 200° C., the jacket temperature was likewise 200° C., and the distillate was condensed in a cold finger condenser having a temperature of 50° C. The polycarbonate polyol from which the distillate was removed was collected in a collecting vessel that was maintained at a constant temperature of 10° C.

This yielded 8676 g of a polycarbonate polyol having an OH value of 56.6 mg KOH/g and a viscosity of 890 mPas (75° C.), as well as 108 g of a distillate having an OH value of 495 mg KOH/g.

### Example 4

Treatment of the Polycarbonate Polyol from Example 2 in Accordance with the Present Invention:

4820 g of the polycarbonate polyol produced in Example 2 were pre-heated to 160° C., and underwent a short-path evaporation at a pressure of <1 mbar over the course of 3 hours. The pre-evaporator was operated at 200° C., the jacket temperature was likewise 200° C., and the distillate was condensed in a cold finger condenser having a temperature of 50° C. The polycarbonate polyol from which the distillate was removed was collected in a collecting vessel that was maintained at a constant temperature of 10° C.

This yielded 4696 g of a polycarbonate polyol having an OH value of 55.2 mg KOH/g and a viscosity of 1000 mPas (75° C.), as well as 74 g of a distillate having an OH value of 465 mg KOH/g.

### Example 5

Preparation of NCO-Terminated Prepolymer from Polycarbonate Polyol of Example 3:

2802 g of the polycarbonate polyol produced in Example 3 were added to 1698 g of 4,4′-diphenylmethane diisocyanate (commercially available from Bayer AG) at 50° C. placed under nitrogen, and the mixture was stirred at 80° C. for 2 hours. The NCO content of the product was determined as 9.96 wt. % NCO, and the viscosity at 70° C. was 1620 mPas. The resultant product (i.e. the NCO terminated prepolymer) was completely clear directly after preparation. Likewise, no clouding was observed following storage of the resultant prepolymer at room temperature for 21 days.

### Example 6

Preparation of NCO-Terminated Prepolymer from Polycarbonate Polyol of Example 4:

2810 g of the polycarbonate polyol produced in Example 4 were added to 1690 g of 4,4′-diphenylmethane diisocyanate (commercially available from Bayer AG) at 50° C. placed under nitrogen, and the mixture was stirred at 80° C. for 2 hours. The NCO content of the resultant product was determined as 10.01 wt. % NCO, and the viscosity at 70° C. was 1625 mPas. The resultant product, i.e. a NCO-terminated prepolymer, was completely clear directly after preparation. Likewise, no clouding was observed following storage of the resultant prepolymer at room temperature for 21 days.

### Example 7

### Comparison Example

1366 kg of a polycarbonate polyol based on hexanediol having an OH value of 58 mg KOH/g (commercially available from Bayer AG) were added to 834 kg 4,4′-diphenylmethane diisocyanate (commercially available from Bayer AG) at 50° C. placed under nitrogen, and the mixture was stirred at 80° C. for 2 hours. The NCO content of the product was determined as 9.97 wt. % NCO, and the viscosity at 70° C. was 1880 mPas. The resultant product (an NCO-terminated prepolymer) showed slight cloudiness directly after preparation. After 2 days' storage of this prepolymer at room temperature, a continuing increase in clouding was observed, with ever-increasing sedimentation after 4 months' storage.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of NCO-terminated prepolymers which are clear and storage-stable at room temperature, comprising
(A) reacting
(1) one or more polycarbonate polyols, with
(2) a stoichiometric excess of 4,4′-diphenylmethane diisocyanate, wherein (1) the polycarbonate polyol is treated by a short-path or thin-film distillation before being being reacted with the 4,4-diphenylmethane diisocyanate, such that the hydroxyl value of the polycarbonate polyol is reduced by at least 1.5 hydroxyl value units.

2. In a process for the preparation of polyurethanes comprising reacting (I) at least one polyisocyanate component with (II) at least one isocyanate-reactive component, the improvement wherein (I) said polyisocyanate component comprises the NCO-terminated prepolymer produced by the process of claim 1.
